(19) United States
(12) Patent Application Publication
(10) Pub. No.: US 2015/0261355 A1
(43) Pub. Date: Sep. 17, 2015

(54) TOUCH PANEL AND HUMAN-COMPUTER INTERACTION DEVICE USING THE SAME

(71) Applicant: TIANJIN FUNAYUANCHUANG TECHNOLOGY CO., LTD., Tianjin (CN)

(72) Inventor: HO-CHIEN WU, New Taipei (TW)

(21) Appl. No.: 14/656,307

(22) Filed: Mar. 12, 2015

(30) Foreign Application Priority Data
Mar. 13, 2014 (CN) 201410092040.3

(51) Int. Cl. G06F 3/044; G06F 1/16

(52) U.S. Cl. CPC G06F 3/044; G06F 1/16

(57) ABSTRACT

The present disclosure relates to a touch panel, the touch panel includes a substrate, a strengthening layer and a touch-control module. The substrate includes a first surface and a second surface opposite to the first surface. The strengthening layer is located on the first surface. The touch-control module is located on the second surface. The strengthening layer is a functional coating layer directly coated on the first surface; a strengthening layer surface, spaced from the substrate, is directly exposed to an application environment; and the strengthening layer surface, spaced from the substrate, is exposed to be in directly contact with touch objects. A human-computer interaction device using the above-described touch panel is also provided.

### CROSS-REFERENCE TO RELATED APPLICATIONS

This application claims all benefits accruing under 35 U.S.C. §119 from China Patent Application No. 201410092040.3, filed on Mar. 13, 2014, in the China Intellectual Property Office, the contents of which are hereby incorporated by reference.

### BACKGROUND

1. Technical Field

The disclosure generally relates to a touch panel without a glass protective layer, and a human-computer interaction device incorporating the touch panel.

2. Description of Related Art

Following an advancement of light and thin electronic products, the problem of how to reduce a thickness of touch panel and human-computer interaction devices has become important.

Conventional touch panels mostly have a double layer structure. The double layer structure includes a substrate, a protective layer, and a conductive layer located between the substrate and the protective layer. Generally, the conductive layer is an indium tin oxide (ITO) layer or an antimony tin oxide (ATO) layer. However, the ITO layer or the ATO layer has poor mechanical durability, and low chemical endurance. Thus, the protective layer is necessary to protect the ITO layer or the ATO layer, while they are used in touch panel. A material of the protective layer is glass. Glass is brittle, easily scratched, and relatively thick, which tends to reduce durability and increase thickness of the touch panel and human-computer interaction device incorporating the touch panel.

### BRIEF DESCRIPTION OF THE DRAWING

Implementations of the present technology will now be described, by way of example only, with reference to the attached figures.

FIG. 1 is a top schematic view of a first embodiment of a touch panel.

FIG. 2 is a scanning electron microscope (SEM) image of a drawn carbon nanotube film.

FIG. 3 is a structure view of the drawn carbon nanotube film of FIG. 2.

FIG. 4 a schematic view of one embodiment of a carbon nanotube layer.

FIG. 5 is a schematic view of one embodiment of a carbon nanotube wire structure.

FIG. 6 is another schematic view of one embodiment of the carbon nanotube wire structure.

FIG. 7 is an SEM image of a twisted carbon nanotube wire.

FIG. 8 is an SEM image of an untwisted carbon nanotube wire.

FIG. 9 is a connection diagram of a driving circuit and a sensing circuit of the touch panel.

FIG. 10 is a cross-sectional schematic view of a second embodiment of a human-computer interaction device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

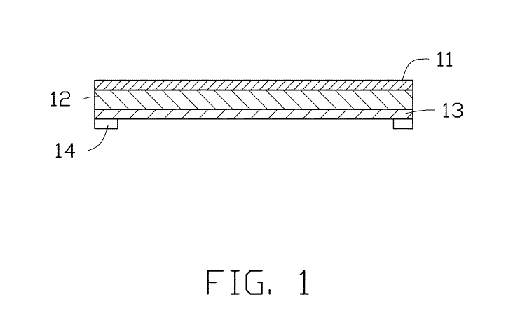

FIG. 1 illustrates that a first embodiment of a touch panel 10 includes a strengthening layer 11, a substrate 12 and a touch-control module. The touch-control module includes a carbon nanotube layer 13, a plurality of first electrodes 14 and a plurality of second electrodes 15. The substrate 12 has a first surface (not shown) and a second surface (not shown) opposite to the first surface. The strengthening layer 11 is located on the first surface. A strengthening layer surface spaced from the substrate 12 can be used as a touch surface, and the touch surface can achieve location by sensing a change in capacitance or resistance of the carbon nanotube layer 13 caused by a touch. The strengthening layer surface spaced from the substrate 12 is directly exposed to an environment. The strengthening layer 11 has an exposed surface. The touch panel 10 can be operated by directly touching the exposed surface with touch objects, such as a finger, without providing a protective layer on the strengthening layer surface spaced from the substrate 12. The plurality of first electrodes 14 and the plurality of second electrodes 15 can be located on a surface of the carbon nanotube layer 13 and electrically connected to the carbon nanotube layer 13.

The strengthening layer 11 is configured to improve performances of the substrate 12, such as improve an anti-reflective property and hardness of the substrate 12. The strengthening layer 11 can be a functional coating layer directly coated on the first surface of the substrate 12. The functional coating layer can be anti-reflection coating (AG coating), hardening coating (HC coating), and/or the like. In one embodiment, the strengthening layer 11 is a mixed coating composed by AG coating and HC coating. A thickness of the strengthening layer 11 ranges from about 3 microns to about 10 microns. If the thickness of the strengthening layer 11 is too small, such as less than 3 microns, it can not play a good role in strengthening the substrate 12; and if the thickness of the strengthening layer 11 is too large, such as more than 10 microns, it will increase a thickness of the touch panel 10.

The substrate 12 can be a planar structure or a curved structure. The substrate 12 is used to support and protect the touch-control module. The substrate 12 has an acceptable transparency. A material of the substrate 12 can be a rigid material or a flexible material. The flexible material can be plastic or resin, such as polyethylene terephthalate (PET), poly methyl methacrylate (PMMA), polycarbonate (PC), Polyether sulfone (PES), cellulose acetate, polyvinyl chloride (PVC), benzocyclobutene (BCB), and acrylic resin. The rigid material can be glass or crystal. In one embodiment, the material of the substrate 12 is polyethylene terephthalate (PET). In another embodiment, the material of the substrate 12 is poly methyl methacrylate (PMMA). A thickness of the substrate 12 ranges from about 0.02 millimeters to about 1 centimeter. A length and a width of the substrate 12 are not limited and can be selected according to need. In one embodiment, the thickness of the substrate 12 ranges from about 0.02 millimeters to about 1 millimeters. It is to be understood that the material of substrate 12 should not be restricted to the above-mentioned materials, but can be any of various other materials that can provide a suitable transparency and strength of substrate 12.

The carbon nanotube layer 13 can be a single carbon nanotube film. A length and width of the carbon nanotube layer 13 are not limited and can be selected according to need. The carbon nanotube layer 13 can also be two or more stacked carbon nanotube films. Adjacent carbon nanotube films can be combined by only the van der Waals force. An angle between the aligned directions of the carbon nanotubes in two adjacent carbon nanotube films can range from about 0 degrees to about 90 degrees. Thus, a thickness of the carbon nanotube layer 13 can be set as desired and in a range where the carbon nanotube layer 13 has an acceptable transparency.

The carbon nanotube film is formed by a plurality of carbon nanotubes, ordered or otherwise, and has a uniform thickness. The carbon nanotube film can be an ordered film or a disordered film. Disordered carbon nanotube film includes, but is not limited to, to a film where the carbon nanotubes are arranged along many different directions, and the aligning directions of the carbon nanotubes are random. The number of the carbon nanotubes arranged along each different direction can be almost the same (e.g. uniformly disordered). The carbon nanotubes in the disordered carbon nanotube film can be entangled with each other. Ordered carbon nanotube film includes, but is not limited to, to a film where the carbon nanotubes are arranged in a consistently systematic manner, e.g., the carbon nanotubes are arranged approximately along a same direction and/or have two or more sections within each of which the carbon nanotubes are arranged approximately along a same direction (different sections can have different directions).

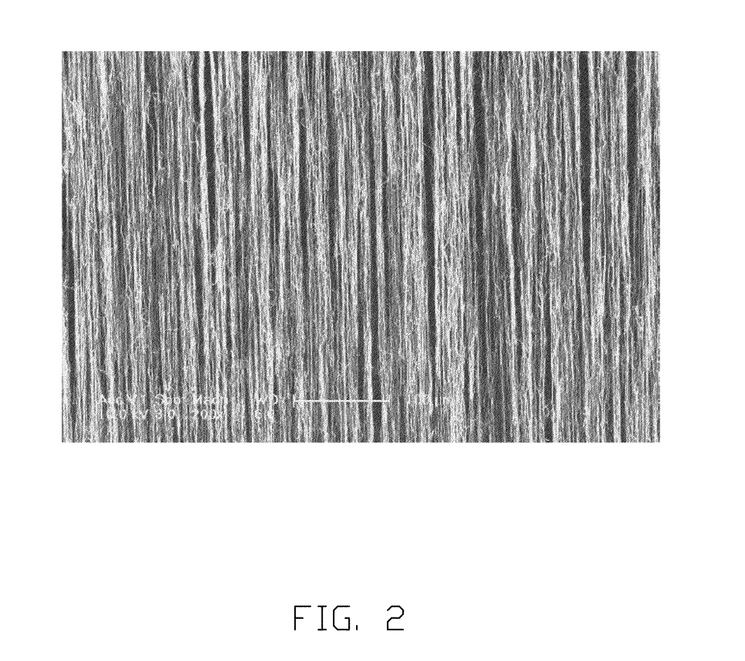

FIG. 2 illustrates that in one embodiment, the carbon nanotube film can be formed by drawing from a carbon nanotube array. In a drawn carbon nanotube film drawn from the carbon nanotube array, a majority of the carbon nanotubes are substantially extended along the same direction parallel to a surface of the drawn carbon nanotube film. Along an extended direction of the carbon nanotubes, each carbon nanotube is joined to adjacent carbon nanotubes end to end by van der Waals force, whereby the drawn carbon nanotube film is capable of being a free-standing structure. The term “free-standing structure” means that the drawn carbon nanotube film can sustain the weight of itself when it is hoisted by a portion thereof without any significant damage to its structural integrity. Thus, the drawn carbon nanotube film can be suspended by two spaced supports. The drawn carbon nanotube film is an electrically anisotropic film. A conductivity of the drawn carbon nanotube film along an extending direction of the carbon nanotubes is more than the conductivities of the drawn carbon nanotube film along the other directions. The extending direction of the carbon nanotubes is the lowest impedance direction D; and a direction perpendicular to the extending direction of the carbon nanotubes is the highest impedance direction H. The single carbon nanotube film can achieve a patterned effect without additional patterning process. There may be a minority of carbon nanotubes in the drawn carbon nanotube film that are randomly aligned. However, the number of randomly aligned carbon nanotubes is very small and does not affect the overall oriented alignment of the majority of carbon nanotubes in the drawn carbon nanotube film. The majority of the carbon nanotubes in the drawn carbon nanotube film that are substantially aligned along the same direction may not be exactly straight, and can be curved at a certain degree, or are not exactly aligned along the overall aligned direction, and can deviate from the overall aligned direction by a certain degree. Therefore, partial contacts can exist between the randomly aligned carbon nanotubes and adjacent carbon nanotubes. The drawn carbon nanotube film has conductivity along the highest impedance direction H, however, the conductivity resistance along the highest impedance direction H is smaller than other directions.

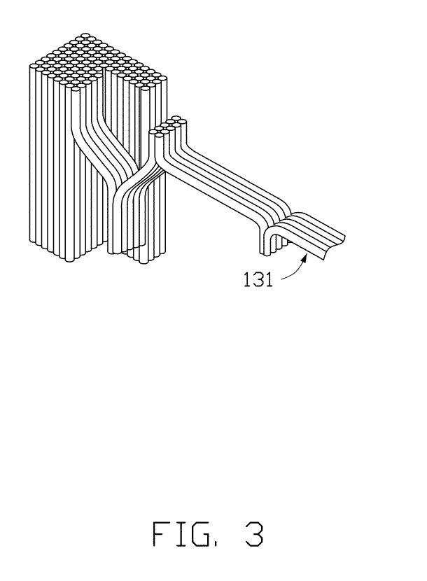

Referring to FIG. 3, the drawn carbon nanotube film includes a plurality of successively oriented carbon nanotube segments 131 joined end-to-end by van der Waals force. Each carbon nanotube segment 131 includes a plurality of carbon nanotubes substantially parallel to each other, and combined by van der Waals force. A thickness of the drawn carbon nanotube film ranges from about 0.5 nanometers to about 100 micrometers. A width is related to a size of a carbon nanotube array that is capable of having a film drawn therefrom.

The drawn carbon nanotube film is substantially a pure film and consists essentially of just the carbon nanotubes. A preparation method of the drawn carbon nanotube film is taught by US Patent Application Publication US 20080248235A1 to Feng et al.

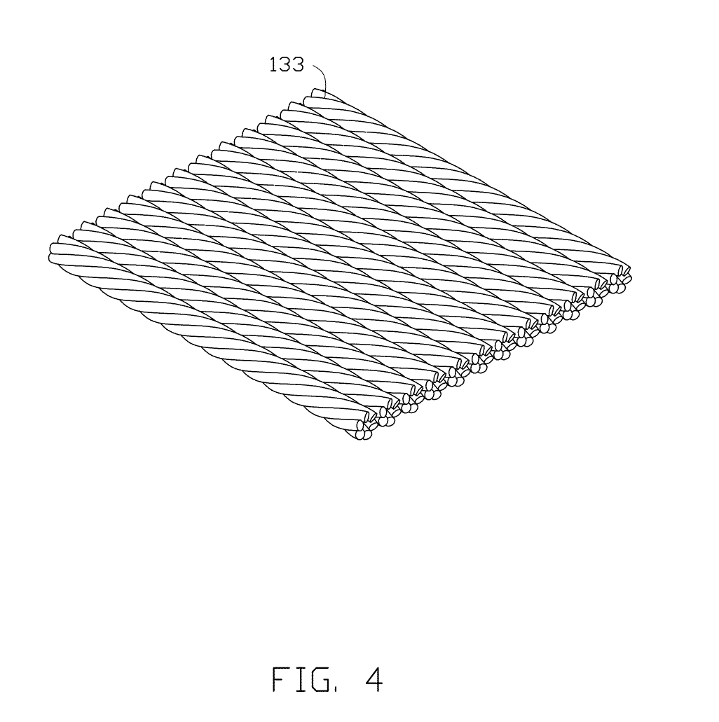

The carbon nanotube layer 13 is not limited the drawn carbon nanotube film, it can also be composed by a plurality of carbon nanotube wire structures 133. Referring to FIG. 4, the plurality of carbon nanotube wire structures 133 arranged in parallel. The plurality of carbon nanotube wire structures 133 is spaced from each other.

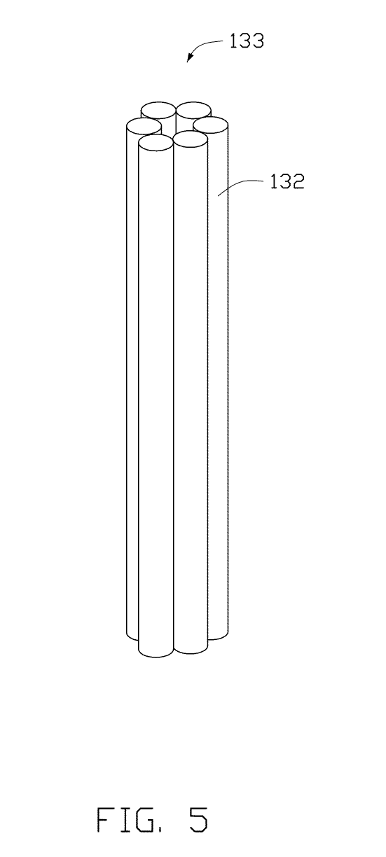

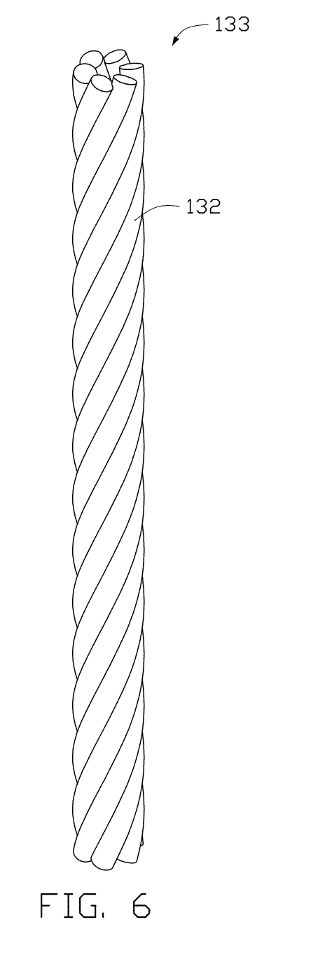

Referring to FIG. 5, each of the plurality of the carbon nanotube wire structure 133 includes a plurality of carbon nanotube wires 132 substantially parallel with each other. Referring to FIG. 6, each of the plurality of the carbon nanotube wire structure 133 includes a plurality of carbon nanotube wires 132 twisted with each other.

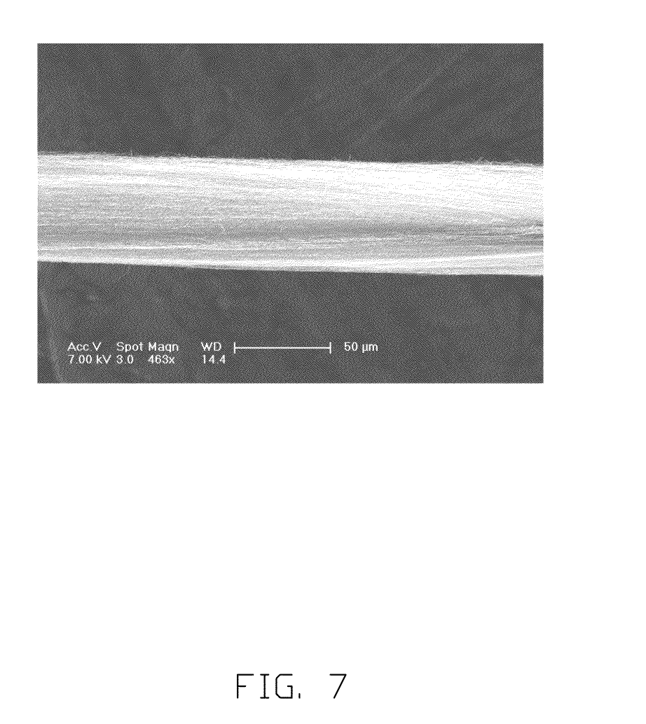

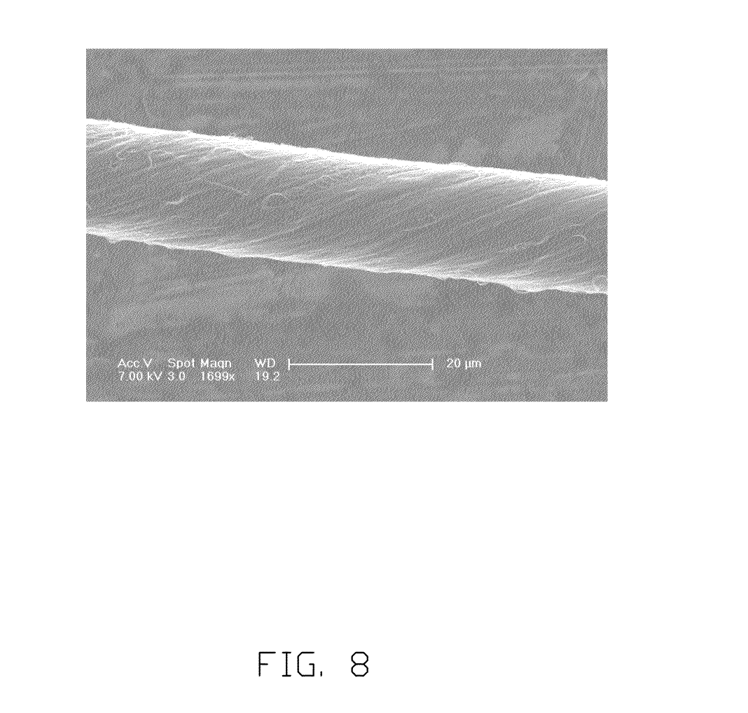

The carbon nanotube wire 132 can be twisted or untwisted. The twisted carbon nanotube wire 132 can be formed by twisting the drawn carbon nanotube film using a mechanical force to turn the two ends of the drawn carbon nanotube film in opposite directions. Referring to FIG. 7, the untwisted carbon nanotube wire 132 includes a plurality of carbon nanotubes substantially oriented along a same direction (i.e., a direction along the length of the untwisted carbon nanotube wire 132. Referring to FIG. 8, the twisted carbon nanotube wire 132 includes a plurality of carbon nanotubes helically oriented around an axial direction of the twisted carbon nanotube wire 132. A length of the carbon nanotube wire structures 133 can be set as desired. In one embodiment, the length of the carbon nanotube wire structures 133 is in a range from about 0.5 nanometers to about 100 micrometers.

The carbon nanotube layer 13 is a substantially pure structure of the carbon nanotubes, with few impurities. The carbon nanotubes have low specific surface area, and are combined by van der Waals force. Thus, the carbon nanotube layer has viscosity and can be adhered directly on the substrate 12 without a transparent and insulated adhesive. It is to be understood that the carbon nanotube layer can also be adhered on the substrate 12 by a transparent and insulated adhesive layer (not shown). The transparent and insulated adhesive layer can be thermal sensitive adhesive, pressure sensitive adhesive, photo sensitive adhesive or the like. A thickness of the transparent and insulated adhesive layer can be in a range from about 4 micros to about 8 micros. In one embodiment, the carbon nanotube layer 13 is adhered on the second surface of the substrate 12 by Optically Clear Adhesive (OCA).

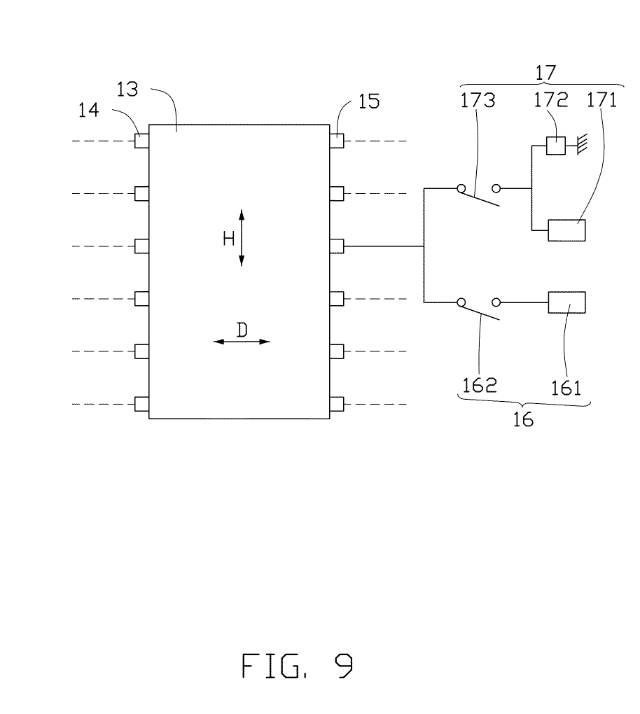

Referring to FIG. 9, the carbon nanotube layer 13 includes a first side and a second side opposite to the first side (not shown), both the first side and the second side are perpendicular to the extending direction of the carbon nanotubes. In one embodiment, the touch-control module includes six first electrodes 14 and six second electrodes 15. The six first electrodes 14 and the six second electrodes 15 are located on a carbon nanotube layer surface spaced from the substrate 12. The six first electrodes 14 are located on the first side, and spaced from each other. The six second electrodes 15 are located on the second side, and spaced from each other. The six first electrodes 14 and the six second electrodes 15 are electrically connected to carbon nanotube layer 13.

The number and location of the plurality of first electrodes 14 and the plurality of second electrodes 15 are not limited and can be selected according to need. The plurality of first electrodes 14 and the plurality of second electrodes 15 can also be located on a carbon nanotube layer surface close to the substrate 12. The plurality of first electrodes 14 and the plurality of second electrodes 15 can also be located on the same side, such as the first side, the second side or other sides.

The plurality of first electrode 14 and the plurality of second electrode 15 can be made by a method such as screen printing, chemical vapor deposition, or magnetron sputtering. A thickness of the plurality of first electrodes 14 or the plurality of second electrodes 15 is in a range from about 10 nm to about 500 microns. The plurality of first electrodes 14 and the plurality of second electrodes 15 are made of conductive materials. A structure of the plurality of first electrodes 14 and the plurality of second electrodes 15 is not limited and can be lamellar, wire, ribbon, block or other structure. A material of the plurality of first electrodes 14 and the plurality of second electrodes 15 can be chosen from a group that includes metal, alloy, indium tin oxide, antimony tin oxide, conductive silver glue, conductive polymer, conductive carbon nanotubes, and so on. A material of the metal or alloy includes aluminum, copper, tungsten, molybdenum, gold, titanium, neodymium, palladium, cesium, silver, or any combination thereof.

In one embodiment, the plurality of first electrodes 14 and the plurality of second electrodes 15 are made by printing conductive silver slurry. A signal input to the carbon nanotube layer 13 from the plurality of first electrodes 14 and the plurality of second electrodes 15 is mainly transported along the lowest impedance direction D. The touch panel 10 can determine a touch point position by a directional signal transmission. Each of the plurality of first electrodes 14 and the plurality of second electrodes 15 is connected to a driving circuit 16 and a sensing circuit 17.

The driving circuit 16 includes a charging circuit 161 and a first switch 162. The first switch 162 is used to control the charging circuit 161. The charging circuit 161 is connected in series with each of the plurality of first electrodes 14 or the plurality of second electrodes 15 by the first switch 162. The charging circuit 161 can be connected to a voltage source (not shown). The sensing circuit 17 includes a memory circuit 171, a readout circuit 172, and a second switch 173. The second switch 173 is used to control the memory circuit 171 and the readout circuit 172. The memory circuit 171 is connected in parallel with the readout circuit 172. The memory circuit 171 is connected in series with each of the plurality of first electrodes 14 or the plurality of second electrodes 15 by the second switch 173. The driving circuit 16 and the sensing circuit 17 are connected in parallel to each other. The memory circuit 171 can be connected in series with a resistor (not shown), for example the memory circuit 171 is connected to ground through the resistor.

Compared with conventional touch panels, the touch panel 10 can have many advantages

The strengthening layer surface spaced from the substrate 12 is directly exposed to the application environment and directly contacts with air. The touch panel 10 can be touched by touch objects, such as a finger, directly touching the exposed surface, without providing a protective layer on the strengthening layer surface spaced from the substrate 12. The touch panel 10 achieves touch location by sensing a change in capacitance or resistance of the carbon nanotube layer caused by a touch. Thus, a thickness and weight of the touch panel 10 are smaller than conventional touch panels. The thickness of the touch panel 10 is less than 1 millimeter. In one embodiment, the thickness of the touch panel 10 is in a range from about 0.04 millimeters to about 1 millimeter.

The carbon nanotubes have excellent shock resistance. Therefore, when the strengthening layer 11 is directly touched by touch objects without the protective layer, the touch panel 10 will not be damaged.

The carbon nanotubes have excellent flexibility and resistance to bending, thus, the touch panel 10 can be a 3D surface.

The carbon nanotube layer 13 is fixed on a surface of the substrate 12 by the transparent and insulated adhesive. Thus, the carbon nanotube layer 13 is adhered to the substrate 12 more firmly, which can prevent a carbon nanotube layer displacement during use.

The carbon nanotubes of the carbon nanotube layer 13 are combined by van der Waals force, which can prevent carbon nanotube displacement of the carbon nanotube layer 13 caused by a touch in different directions; and prevent the carbon nanotube layer 13 from tearing, breaking, etc.

Glass is brittle, easily scratched, and relatively thick, which tends to reduce durability and increase thickness of touch panels. The touch panel 10 does not have a protective layer made of glass, which can reduce the thickness and the cost of the touch panel 10.

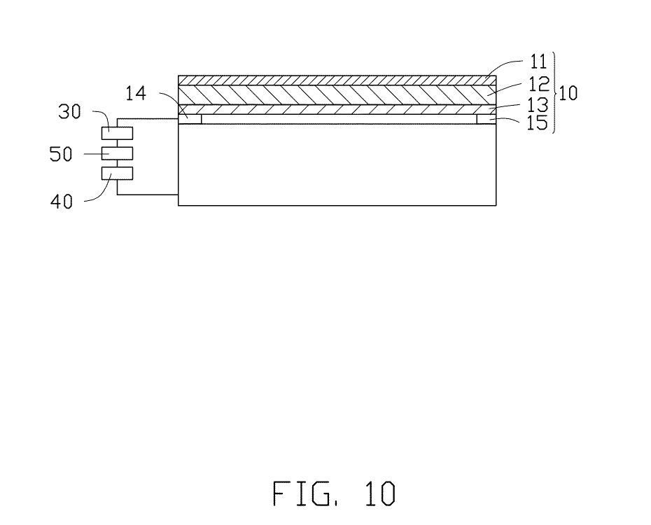

Referring to FIGS. 10 and 1, a second embodiment of a human-computer interaction device 100, the human-computer interaction device 100 includes the touch panel 10 and electronic equipment 20. The touch panel 10 is located at a position that corresponds to an interactive interface of the electronic equipment 20. The touch panel 10 is used to identify a user touch operation and transmit a touch command to the electronic equipment 20. The touch panel 10 includes a strengthening layer 11, a substrate 12 and a touch-control module. The touch-control module includes a carbon nanotube layer 13, a plurality of first electrodes 14 and a plurality of second electrodes 15. The substrate 12 has a first surface (not shown) and a second surface (not shown) opposite to the first surface. The strengthening layer 11 is located on the first surface, a strengthening layer surface spaced from the substrate 12 can be used as touch surface, and the touch surface achieves positioning by sensing a change in capacitance or resistance of the carbon nanotube layer caused by a touch. The strengthening layer 11 having a surface exposed by the strengthening layer surface spaced from the substrate 12 directly to the application environment. The touch panel 10 can be operated by directly touching the exposed surface with touch objects, such as a finger, without providing a protective layer on the strengthening layer surface. The plurality of first electrodes 14 and the plurality of second electrodes 15 can be located on a surface of the carbon nanotube layer 13 and electrically connected to the carbon nanotube layer 13.

The electronic equipment 20 can be any electronic device with a human-machine interface, such as a display device or a switching device. The number of the electronic equipment 20 can be one or at least two. A display surface of the device or switch device is flat or curved. The display device can be a monochrome display, color graphics adapter (CGA) display, enhanced graphics adapter (EGA) display, variable-graphics-array (VGA) display, super VGA display, liquid crystal display (LCD), cathode ray tube (CRT), plasma displays and the like. The display device can also be a flexible liquid crystal display (LCD), flexible electrophoretic display, flexible organic electroluminescent display and the like. In one embodiment, the display device is thin-film transistor (TFT) liquid crystal display.

The human-computer interaction device 100 can further include a light guide plate (not shown). The light guide plate is located between the electronic equipment 20 and the touch panel 10. The light guide plate can guide lights from a point or a line light source emitted from a plane. The light guide plate can also improve an emission luminance uniformity of the electronic equipment 20. The light guide plate is an optional element and can be set as desired.

The human-computer interaction device 100 can further include a touch panel controller 30, an electronic equipment controller 40, and a central processing unit (CPU) 50. The touch panel controller 30, the CPU 50, and the electronic equipment controller 40 are electrically connected. The touch panel controller 30 is electrically connected to the plurality of first electrodes 14 and the plurality of second electrodes 15. The electronic equipment controller 40 is electrically connected to the electronic equipment 20.

When the human-computer interaction device 100 works, the touch panel controller 30 locates and selects an information input according to an icon or menu position touched by touch objects; and transports the information to the CPU 50. The CPU 50 controls the electronic equipment 20 by the electronic equipment controller 40.

It is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. A touch panel comprising:
a substrate comprising a first surface and a second surface opposite to the first surface;
a strengthening layer located on the first surface; and
a touch-control module located on the second surface;
wherein the strengthening layer is a functional coating layer directly coated on the first surface; a strengthening layer surface, spaced from the substrate, is directly exposed to an application environment; and the strengthening layer surface, spaced from the substrate, is exposed to be in directly contact with touch objects.

2. The touch panel of claim 1, wherein a material of the substrate is polyethylene terephthalate or poly methyl methacrylate.

3. The touch panel of claim 1, wherein touch-control module comprises a carbon nanotube layer.

4. The touch panel of claim 3, wherein the carbon nanotube layer is adhered on the second surface.

5. The touch panel of claim 3, wherein the carbon nanotube layer is a single carbon nanotube film or at least two stacked carbon nanotube films.

6. The touch panel of claim 1, wherein the functional coating layer is at least one of an anti-reflection coating and a hardening coating.

7. The touch panel of claim 1, wherein the exposed surface has no protective layer.

8. The touch panel of claim 1, wherein a thickness of the strengthening layer ranges from about 3 microns to about 10 microns.

9. The touch panel of claim 1, wherein a thickness of the touch panel is less than 1 millimeter.

10. The touch panel of claim 7, wherein the thickness of the touch panel is in a range from about 0.04 millimeters to about 1 millimeter.

11. The touch panel of claim 3, wherein the carbon nanotube layer comprises a first side and a second side opposite to the first side; a plurality of first electrodes are located on the first side, and spaced from each other; and a plurality of second electrodes are located on the second side, and spaced from each other.

12. A human-computer interaction device comprising:
a touch panel comprising:
a substrate comprising a first surface and a second surface opposite to the first surface;
a strengthening layer located on the first surface and comprising an exposed surface; and
a touch-control module located on the second surface,
wherein the strengthening layer is a functional coating layer directly coated on the first surface; a strengthening layer surface, spaced from the substrate, is directly exposed to an application environment; and the strengthening layer surface, spaced from the substrate, is exposed to be in directly contact with touch objects; and
at least one electronic equipment comprising an interactive interface corresponds to the touch panel.

13. The human-computer interaction device of claim 12, wherein a thickness of the touch panel is less than 1 millimeter.

14. The human-computer interaction device of claim 12, wherein the touch-control module comprises a carbon nanotube layer.

15. The human-computer interaction device of claim 12, wherein a material of the substrate is polyethylene terephthalate or poly methyl methacrylate.

16. The human-computer interaction device of claim 12, wherein the functional coating layer is at least one of an anti-reflection coating and a hardening coating.

17. The human-computer interaction device of claim 12, further comprising a backlight module located between the at least one electronic equipment and the touch panel.

18. The human-computer interaction device of claim 12, wherein the at least one electronic equipment is a display device or a switching device.

19. The human-computer interaction device of claim 18, wherein a display surface of the display device or switch device is flat or curved.
